(19) United States
(12) Patent Application Publication
(10) Pub. No.: US 2026/0145593 A1
(43) Pub. Date: May 28, 2026

(54) BRAKE DEVICE OF VEHICLE SEAT

(71) Applicant: TF-METAL Co., Ltd., Kosai-shi (JP)

(72) Inventors: Chieko OKUYAMA, Kosai-shi (JP); Tatsuhiko OGUCHI, Kosai-shi (JP)

(73) Assignee: TF-METAL Co., Ltd., Kosai-shi, Shizuoka (JP)

(21) Appl. No.: 19/402,632

(22) Filed: Nov. 26, 2025

(30) Foreign Application Priority Data
Nov. 27, 2024 (JP) 2024-205866

(51) Int. Cl. B60N 2/16

(52) U.S. Cl. CPC B60N 2/168

(57) ABSTRACT

Brake device of vehicle seat has brake mechanism section (9) which causes pinion shaft (12) to be in a braking state so that pinion shaft (12) does not rotate against a reverse input, and drive mechanism section (10) which, when rotating operation lever (5) in one of forward or reverse rotational direction from a neutral position, releases the braking state of pinion shaft (12) and allows rotation of pinion shaft (12) in the one of forward or reverse rotational direction. Brake mechanism section (9) has housing (11) having, on its inner peripheral surface, cylindrical tubular frictional surface (13). Drive mechanism section (10) has drive wheel (18) that releases the braking state of pinion shaft (12) and rotates pinion shaft (12) integrally with operation lever (5). Drive wheel (18) has frictional resistance portions (30) that come into elastically press-contact with cylindrical tubular frictional surface (13) at at least three circumferential positions.

### TECHNICAL FIELD

The present invention relates to a brake device of a vehicle seat which is installed in a position adjustment mechanism such as a seat lifter mechanism for adjusting a height position of a seat cushion serving as a seat surface, and a seat reclining mechanism for adjusting an angular position of a seat back serving as a seat backrest.

### BACKGROUND

This type of brake device of the vehicle seat has been proposed in Japanese Unexamined Patent Application Publication No. 2017-114472 (hereinafter is referred to as “JP2017-114472”).

The brake device disclosed in JP2017-114472 is installed in a seat lifter mechanism. This brake device is configured to transmit an operation force in a forward or reverse rotational direction input from an operation lever to an output shaft through an input-side clutch and an output-side clutch, and to output it to the vehicle seat.

The input-side clutch is configured such that a disk-shaped wedge cam as an input-side inner-ring member is accommodated and disposed inside an input-side outer-ring member. Furthermore, a wave washer as a rotation suppressing member is provided in a press-contact state between the input-side outer-ring member and a release bracket.

When releasing a rotational operation of the operation lever and returning the operation lever to a neutral position, rotation of a returning movement of the input-side inner-ring member (the wedge cam) is transmitted to the input-side outer-ring member, then the input-side outer-ring member tends to be dragged (rotated together with the input-side inner-ring member (the wedge cam). However, by an urging force of the wave washer, the drag rotation of the input-side outer-ring member is suppressed. That is, the wave washer applies the urging force to the input-side outer-ring member so as to press the input-side outer-ring member against a housing through the input-side inner-ring member (the wedge cam) in an axial direction, thereby suppressing the drag rotation of the input-side outer-ring member.

### SUMMARY OF THE INVENTION

In the brake device disclosed in JP2017-114472, however, as an additional element, the wave washer is necessary to suppress the drag rotation of the input-side outer-ring member. This causes an increase in parts count, and result in a deterioration in manufacturing workability and a rise in manufacturing costs.

The present invention was made in view of the above technical problem of the related art. An object of the present invention is therefore to provide a brake device of a vehicle seat which is capable of reducing parts count, which in turn improving manufacturing workability and reducing manufacturing costs.

According to one aspect of the present invention, a brake device of a vehicle seat comprises: a brake mechanism section including a drive-side gear provided at one end of an output shaft, the brake mechanism section configured to cause the output shaft to be in a braking state so that the output shaft does not rotate against a reverse input that is input from a drive-side gear side; and a drive mechanism section configured to, when operating and rotating an operating member in either one of forward or reverse rotational direction from a neutral position, release the braking state of the output shaft and allow rotation of the output shaft in the one of forward or reverse rotational direction. The brake mechanism section and the drive mechanism section are provided in a seat adjuster of the vehicle seat, and are coaxially aligned with each other. The brake mechanism section further includes a brake housing having, on an inner peripheral surface thereof, a cylindrical tubular frictional surface. The drive mechanism section includes a drive wheel disposed inside the brake housing and structured to release the braking state of the output shaft and further drive and rotate the output shaft integrally with the operating member. The drive wheel has, on an outer periphery thereof, frictional resistance portions that come into press-contact with the cylindrical tubular frictional surface of the brake housing by elastic force of the frictional resistance portions at at least three positions in a circumferential direction of the drive wheel.

According to the present invention, it is possible to reduce parts count, which in turn improve manufacturing workability and reduce manufacturing costs.

### BRIEF DESCRIPTION OF THE DRAWINGS

FIG. 1 is a perspective view showing an example of a vehicle seat having, as position adjustment mechanisms, a seat lifter mechanism and a seat reclining mechanism.

FIG. 2 is a right side view of a brake device according to the present invention.

FIG. 3 is a front view of the brake device shown in FIG. 2.

FIG. 4 is a perspective view of the brake device shown in FIG. 2.

FIG. 5 is a sectional view taken along a line A-A of FIG. 3.

FIG. 6 is an exploded perspective view of the brake device shown in FIG. 2, showing each component of a brake mechanism section and a drive mechanism section.

FIG. 7 is an explanatory diagram showing a neutral state of the brake mechanism section with the drive mechanism section removed.

FIG. 8 is a perspective view of a pinion shaft used in the present embodiment.

FIG. 9 is a front view of a drive wheel used in the present embodiment.

FIG. 10 is a sectional view taken along a line B-B of FIG. 9.

FIG. 11 is a perspective view of the drive wheel used in the present embodiment.

FIG. 12 is a perspective view of a cover member used in the present embodiment.

FIG. 13 is a front view showing the drive mechanism section with a lever bracket and the cover member removed.

FIGS. 14A to 14C show a state in which the lever bracket is rotated in a clockwise direction from a neutral position. FIG. 14A is a front view when viewed from the lever bracket side. FIG. 14B is a front view of the drive mechanism section with the lever bracket and the cover member removed. FIG. 14C is a front view of the drive wheel with the drive mechanism section removed.

FIGS. 15A to 15C show a state in which the lever bracket is rotated in a counterclockwise direction from the neutral position. FIG. 15A is a front view when viewed from the lever bracket side. FIG. 15B is a front view of the drive mechanism section with the lever bracket and the cover member removed.

FIG. 15C is a front view of the drive wheel with the drive mechanism section removed.

### DETAILED DESCRIPTION

An embodiment of a brake device of a vehicle seat (hereinafter is simply referred to as a “seat”) according to the present invention will be described below with reference to the drawings.

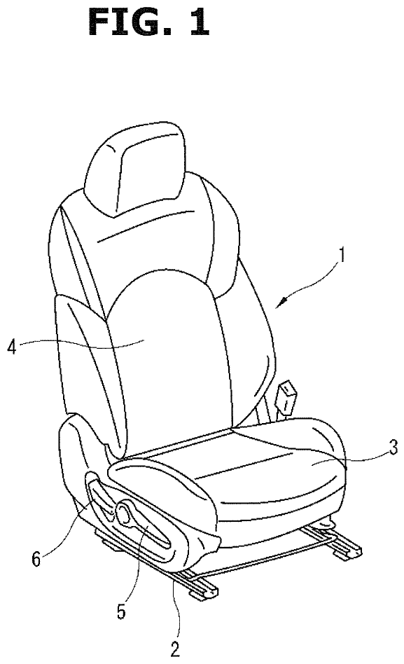

FIG. 1 shows an example of a seat having a position adjustment mechanism.

As illustrated in FIG. 1, a seat 1 has, as so-called position adjustment mechanisms, a seat slide mechanism 2 for adjusting a fore-and-aft position of the seat 1, a seat lifter mechanism for adjusting a height position of a seat cushion 3 serving as a seat surface, and a seat reclining mechanism for adjusting an angular position of a seat back 4 serving as a seat backrest. As seen in FIG. 1, for operating each mechanism, an operation lever 5 as an operating member for the seat lifter mechanism, and an operation lever 6 for the seat reclining mechanism, are provided so as to be arranged in a front-to-rear direction on a side portion of the seat cushion 3.

Here, when focusing attention on the seat lifter mechanism of the seat 1 shown in FIG. 1, as in the well-known seat lifter mechanism, each time the operation lever 5 of the seat lifter mechanism is pulled upwards from its neutral position (in the following description, a state in which the operation lever 5 is at the neutral position is also referred to as a “neutral state”), a position of the seat cushion 3 gradually becomes higher, whereas each time the operation lever 5 is pushed downwards from the neutral position, the position of the seat cushion 3 gradually becomes lower. In this manner, the seat lifter mechanism has a function of adjusting a height position of the seat surface of the seat 1.

### Configuration of Brake Device

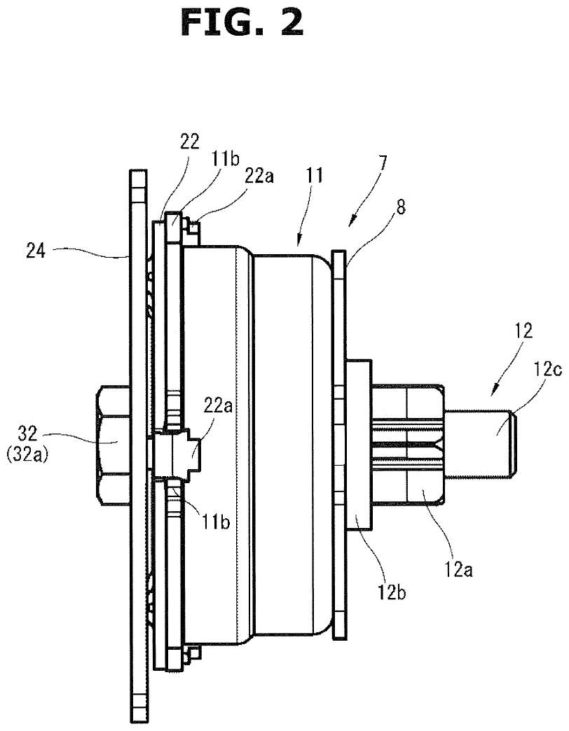

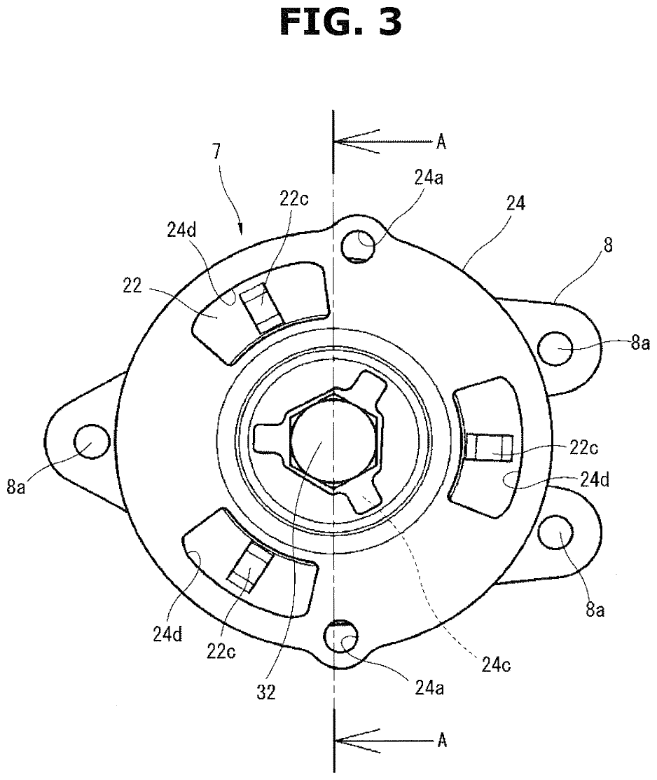

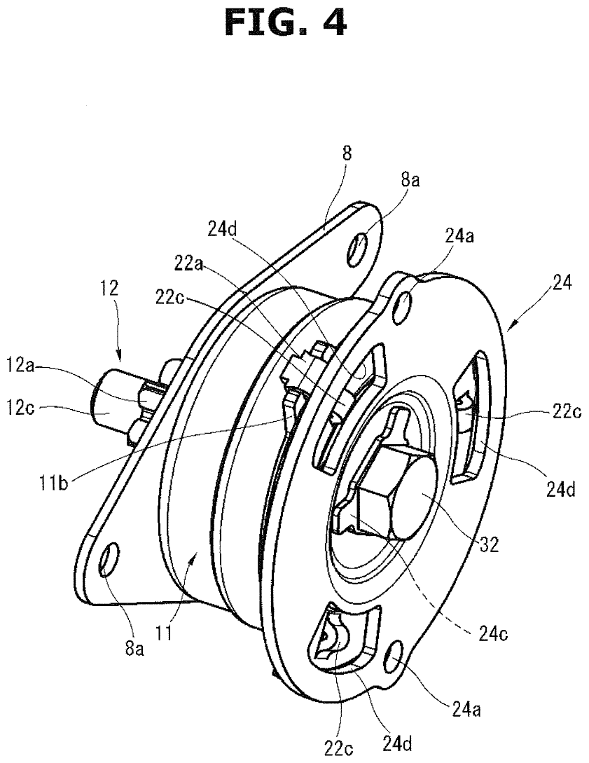

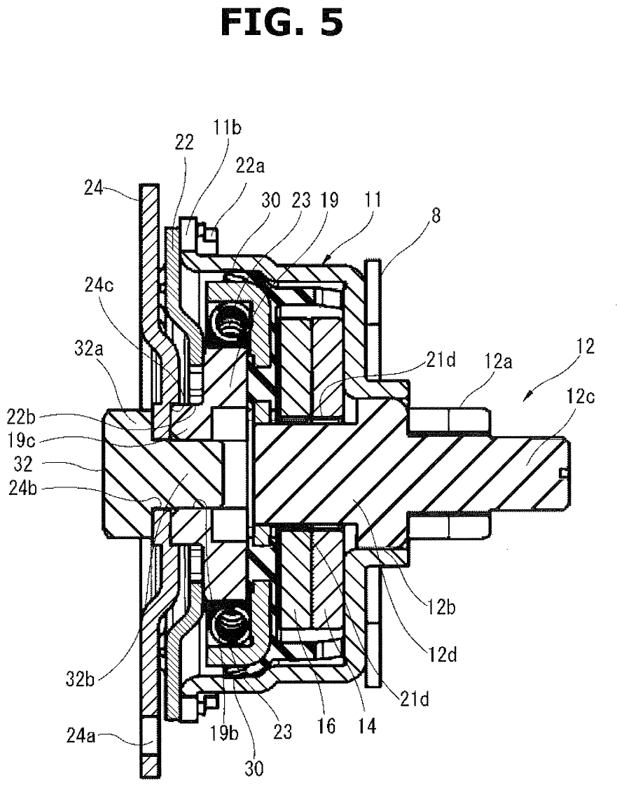

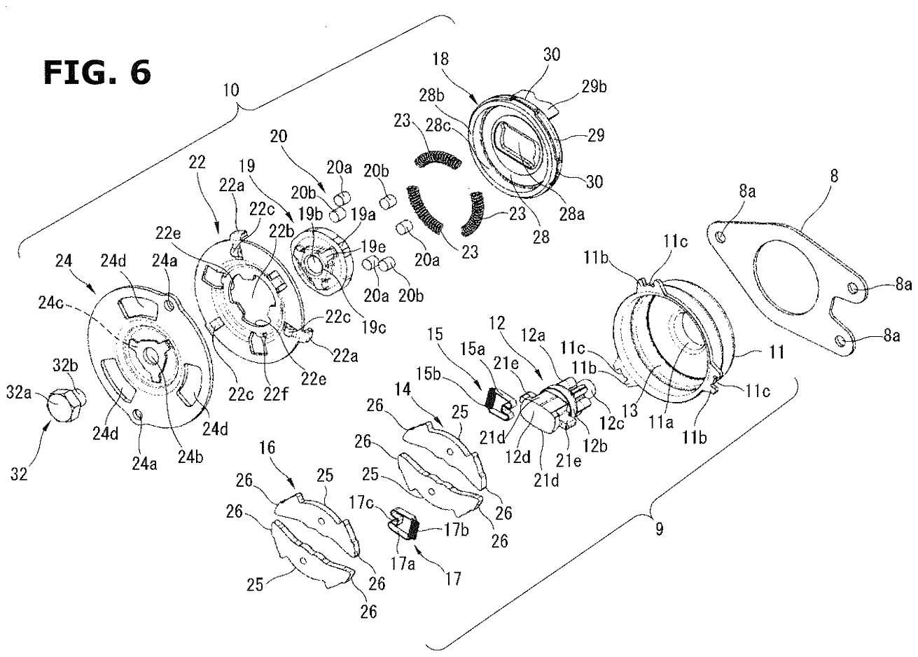

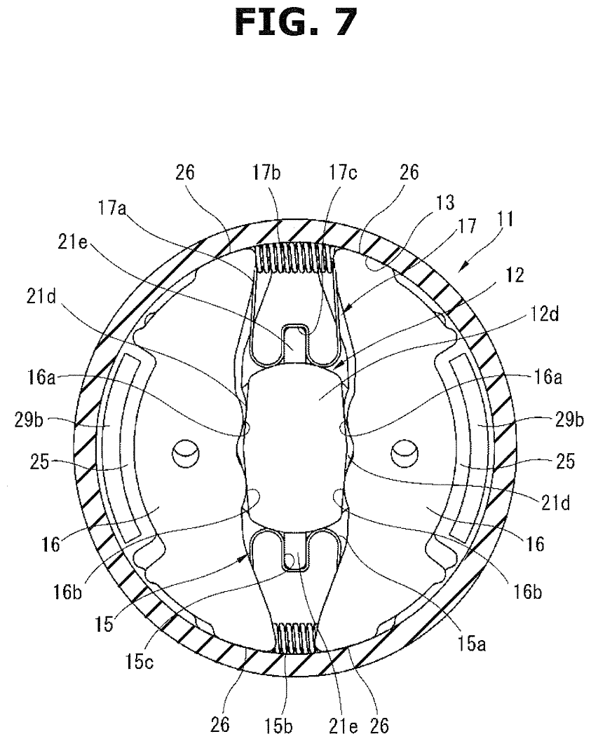

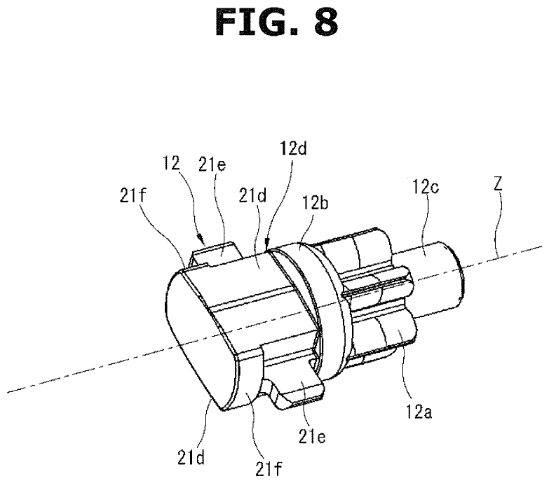

FIG. 2 is a right side view of a brake device according to the present invention. FIG. 3 is a front view of the brake device shown in FIG. 2. FIG. 4 is a perspective view of the brake device shown in FIG. 2. FIG. 5 is a sectional view taken along a line A-A of FIG. 3. FIG. 6 is an exploded perspective view of the brake device shown in FIG. 2, showing each component of a brake mechanism section and a drive mechanism section. FIG. 7 is an explanatory diagram showing a neutral state of the brake mechanism section with the drive mechanism section removed. FIG. 8 is a perspective view of a pinion shaft used in the present embodiment.

In the following description of the drawings, a direction of a rotation axis of an after-mentioned pinion shaft 12 serving as an output shaft is referred to as an “axial direction”. A side corresponding to a right side (a housing 11 side) of FIG. 6 which is close to the seat (not shown) is referred to as an “axial direction inner side”. Furthermore, a side corresponding to a left side (a lever bracket 24 side) of FIG. 6 which is away from the seat (not shown) is referred to as an “axial direction outer side”.

As illustrated in FIG. 2, and as can be seen in the exploded perspective view of FIG. 6, in a brake device 7, a housing 11 as a bottomed cylindrical tubular brake housing and a lid-plate cover member 22 are connected together, then a substantially cylindrical tubular case is formed. Components of a brake mechanism section 9 and some components of a drive mechanism section 10 are coaxially accommodated inside the case.

The pinion shaft 12 used in both of the brake mechanism section 9 and the drive mechanism section 10 is disposed in the axial direction at a center of the inside of the housing 11 forming the case. At one end side of the pinion shaft 12, the lever bracket 24 serving as an operating member together with the operation lever 5 shown in FIG. 1 is arranged rotatably integrally with a wedge cam 19 forming the drive mechanism section 10 with these components being coaxially aligned with the pinion shaft 12. The pinion shaft 12 is provided, at an axial direction inner side end portion thereof, with a pinion gear 12a, as a drive-side gear, which is formed integrally with the pinion shaft 12 and which is exposed to the outside through the housing 11.

The lever bracket 24 can be operated so as to rotate in both forward and reverse rotational directions from its neutral position. The operation lever 5 is fixed to this lever bracket 24 with two screws (not shown) that are inserted into screw insertion holes 24a (described later) formed at an outer peripheral portion of the lever bracket 24.

The brake device 7 is fixed to a side bracket (not shown) of the seat 1 shown in FIG. 1 using three mounting holes 8a of a mounting bracket 8 that is fixed to a bottom surface of the housing 11. Then, the pinion gear 12a of the pinion shaft 12 engages with a driven-side gear (not shown) of the seat lifter mechanism as a drive mechanism of the seat 1.

In this brake device 7, when the lever bracket 24 is at the neutral position, a braking state is maintained so that the pinion shaft 12 does not rotate even if there is a reverse input from the pinion shaft 12 side. On the other hand, when the lever bracket 24 is operated and rotated in either one of the forward or reverse rotational direction from the neutral position, the braking state of the pinion shaft 12 is released, and rotation of the pinion shaft 12 is allowed. This rotation of the pinion shaft 12 is converted into rotation of the driven-side gear (not shown) of the seat lifter mechanism through the pinion gear 12a, and further converted into vertical movement of the seat cushion 3 of the seat 1 through a link mechanism.

It is noted that, in the case of this type of brake device 7, since a stroke of the lever bracket 24 is relatively small, in many cases, by repeating the rotational operation of the lever bracket 24 to a specific direction through the operation lever 5 multiple times, a desired position can be achieved.

As illustrated in FIGS. 2 and 6, as described above, components of the brake mechanism section 9 and some components of the drive mechanism section 10 are accommodated so as to be coaxially and adjacently arranged inside the case formed by the housing 11 and the cover member 22. In the following description, each component and its structure or configuration will be described mainly using FIG. 6 that relatively facilitates the understanding of three-dimensional shape, arrangement, etc. of the component, together with the drawings except FIG. 6 as necessary.

As depicted in FIG. 6, the brake mechanism section 9 includes the housing 11, the pinion shaft 12 rotatably supported by the housing 11, a pair of substantially semicircular opposing lock plates 14 arranged in the housing 11, a lock spring 15 used for the pair of lock plates 14, another pair of opposing lock plates 16 having the same shapes as those of the lock plates 14 and arranged so as to overlap the pair of lock plates 14 at the axial direction outer side of the pair of lock plates 14 in the housing 11, and a lock spring 17 used for the pair of lock plates 16.

The drive mechanism section 10 includes a shallow dish-shaped drive wheel 18 arranged so as to overlap the pair of lock plates 16 at the axial direction outer side of the pair of lock plates 16, the cover member 22 forming the case by being engaged with the housing 11 of the brake mechanism section 9, the disk-shaped wedge cam 19 arranged at the axial direction inner side of the cover member 22, six rollers 20 arranged at each 120°position on an outer peripheral surface of the wedge cam 19, three roller forcing springs 23, and the lever bracket 24 serving as the operating member and arranged at the axial direction outer side of the cover member 22.

The housing 11 of the brake mechanism section 9 shown in FIG. 6 is formed into a substantially deep dish shape by drawing press molding using a sheet metal material having a predetermined thickness. An inner peripheral surface of the housing 11 is a cylindrical tubular frictional surface 13 serving as a braking surface.

The housing 11 has, at a bottom portion thereof, a shaft bore 11a which penetrates the bottom of the housing 11 along the axial direction and into which a large diameter shaft portion 12b, located at the pinion gear 12a side, of the pinion shaft 12 is inserted. This shaft bore 11a is formed into a cylindrical tubular shape having an axially extending flange at its bore edge. In addition, three flange portions 11b extending outwards in a radial direction are formed at an opening edge portion of the housing 11. Each flange portion 11b has, at a top end portion thereof, an engagement recessed portion 11c. This engagement recessed portion 11c is a coupling fixing portion with the after-described cover member 22.

The pinion shaft 12 of the brake mechanism section 9 shown in FIG. 6 has, as illustrated in FIG. 8 as well, the pinion gear 12a as the drive-side gear, the large diameter shaft portion 12b as a bearing portion rotatably supported in the shaft bore 11a of the housing 11, a top end shaft portion 12c provided at a top end portion of the pinion gear 12a, and an irregular shaped shaft portion 12d formed into a substantially rectangular shaft shape and located at an opposite side to the top end shaft portion 12c with respect to the large diameter shaft portion 12b in the axial direction.

The irregular shaped shaft portion 12d of the pinion shaft 12 has a pair of width-across-flat portions (or a pair of dihedral portions) 21d, 21d that are formed substantially parallel to each other (more specifically, that slant to outer arc portions 21f, 21f at a predetermined angle so that a distance between the width-across-flat portions 21d, 21d becomes narrower toward the arc portions 21f, 21f) and that face each other with respect to a rotation center Z of the pinion shaft 12. A pair of width-across-flat portion connecting portions (the pair of arc portions 21f, 21f) connect end portions of the pair of width-across-flat portions 21d, 21d, and thus the irregular shaped shaft portion 12d is substantially oval (elliptical) in cross section. The irregular shaped shaft portion 12d further has a pair of stopper portions 21e, 21e that protrude outwards in a radial direction from the pair of width-across-flat portion connecting portions and that limit an axial movement of the pinion shaft 12. As can be seen in the drawings, the pair of arc portions 21f, 21f are formed with the rotation center Z of the pinion shaft 12 being a center of a curvature, at positions of the width-across-flat portion connecting portions where the stopper portions 21e, 21e are not formed in the axial direction of the pinion shaft 12. Here, the irregular shaped shaft portion 12d and the large diameter shaft portion 12b have the substantially same outside diameter, which corresponds to the maximum diameter of the entire pinion shaft 12. Furthermore, the width-across-flat portions 21d, 21d of the irregular shaped shaft portion 12d function as acting portions that exert external forces on the two sets of lock plates 14 and 16.

The pair of stopper portions 21e, 21e of the pinion shaft 12 are arranged at circumferentially middle positions of the pair of width-across-flat portion connecting portions (the pair of arc portions 21f, 21f) which are positions located symmetrically with respect to the rotation center Z of the pinion shaft 12. Each stopper portion 21e is shaped into a flat plate extending along the radial direction. Furthermore, the pair of stopper portions 21e, 21e are located at the large diameter shaft portion 12b side in the axial direction, and the drive wheel 18 described later can be engaged with the remaining arc portions 21f, 21f.

Moreover, each of the stopper portions 21e, 21e of the pinion shaft 12 has a pair of axial direction surfaces that are substantially flat and parallel to each other, and thus a thickness of each stopper portion 21e is substantially constant in an extending direction (a radial direction) of the surface. In addition, both end surfaces, in the axial direction, of each stopper portion 21e are also substantially flat and parallel to each other, and one end, located at the large diameter shaft portion 12b side, of both end surfaces abuts on an inner bottom surface of the housing 11, thereby limiting the movement, to the axial direction inner side (the seat side), of the pinion shaft 12.

As illustrated in FIGS. 5, 6 and 7, the pair of lock plates 14 of the brake mechanism section 9 are arranged laterally symmetrically or vertically symmetrically so as to face each other, and installed so that the lock plates 14 are seated on the inner bottom surface of the housing 11 and so that outer peripheral surfaces of both end portions of the lock plates 14 come into contact with the cylindrical tubular frictional surface 13. Furthermore, the other pair of opposing lock plates 16 are arranged laterally symmetrically or vertically symmetrically so as to face each other, and installed so as to be stacked on the pair of lock plates 14 in the axial direction of the pinion shaft 12. Each lock plate has, on its outer peripheral surfaces of both end portions separated by a recessed portion 25, arc-shaped brake lock surfaces 26 that can come into contact with the cylindrical tubular frictional surface 13 of the housing 11.

The lock spring 15 as a forcing member is interposed between respective one end portions (respective first end portions) of the lock plates 14, 14. That is, the pair of lock plates 14 are forced by this lock spring 15 in a direction in which the respective one end portions (the respective first end portions) are separated from each other. Likewise, the lock spring 17 as a forcing member is interposed between respective one end portions (respective second end portions) of the lock plates 16, 16. That is, the pair of lock plates 16 are forced by this lock spring 17 in a direction in which the respective one end portions (the respective second end portions) are separated from each other.

The lock springs 15 and 17 are so-called composite springs structured by plate springs 15a, 17a formed by being bent into a shape of M-letter and coil springs 15b, 17b pinched between respective leg end portions of the plate springs 15a, 17a. As shown in FIG. 7, recessed portions 15c, 17c of the substantially M-shaped plate springs 15a, 17a are fitted onto the pair of stopper portions 21e, 21e of the pinion shaft 12, and thus the lock springs 15 and 17 are supported by the pinion shaft 12 through the pair of stopper portions 21e, 21e. The coil springs 15b, 17b force the plate springs 15a, 17a in a direction that spreads both legs of the plate springs 15a, 17a apart.

In the brake mechanism section 9 configured as described above, as illustrated in FIGS. 5, 6 and 7, the pinion shaft 12 is inserted between the opposing lock plates 14, 14 and between the opposing lock plates 16, 16 so that the width-across-flat portions 21d, 21d of the irregular shaped shaft portion 12d are positioned at a gap between the opposing lock plates 14, 14 and at a gap between the opposing lock plates 16, 16. Furthermore, the irregular shaped shaft portion 12d of the pinion shaft 12 is fitted to an after-mentioned rectangular hole 28a of the drive wheel 18 with slight play given so as to be able to slightly rotate by a minute angle.

At this time, as can be seen in FIG. 7 as well, an after-mentioned pair of release nail portions 29b of the drive wheel 18 are fitted in the respective recessed portions 25 of the lock plates 14 and 16 on respective outer peripheral sides of the lock plates 14 and 16 with respective gaps given in a rotational direction of the pinion shaft 12. Arc-shaped outer peripheral surfaces of these release nail portions 29b are in a non-contact state with the cylindrical tubular frictional surface 13 of the housing 11 through respective predetermined width gaps.

In addition, an axial dimension of the release nail portion 29b is set so that even when the release nail portion 29b comes into contact with the inner bottom surface of the housing 11, the release nail portion 29b does not bite the lock plates 14 and 16. With this, a working space of the brake mechanism section 9 is secured.

As seen in FIG. 7, on opposing end surfaces of the lock plates 16, 16 arranged at both sides of the irregular shaped shaft portion 12d of the pinion shaft 12, the lock plates 16, 16 each have, at portions facing the width-across-flat portions 21d, 21d of the irregular shaped shaft portion 12d, arc-shaped convex portions 16a, 16b formed at positions corresponding to right and left two positions of a rotation center of the irregular shaped shaft portion 12d. As described above, the lock spring 17 is interposed between the respective one end portions (the respective second end portions) of the lock plates 16, 16, and the lock plates 16, 16 are forced by this lock spring 17 in the direction in which the respective one end portions (the respective second end portions) are separated from each other.

With this, the lock plates 16, 16 each move (rotate) in opposite rotational directions along the cylindrical tubular frictional surface 13 of the housing 11 by respective predetermined rotational amounts. Therefore, a distance between the respective first end portions of the lock plates 16, 16 is smaller than a distance between the respective second end portions of the lock plates 16, 16. With this configuration, respective one convex portions 16b of the pair of convex portions 16a, 16b formed on the opposing end surfaces of the lock plates 16, 16 are in contact with the width-across-flat portions 21d, 21d of the irregular shaped shaft portion 12d, whereas respective other convex portions 16a are separate from the width-across-flat portions 21d, 21d of the irregular shaped shaft portion 12d.

The pair of lock plates 14 also have the same mechanical relationship. That is, the lock spring 15 is interposed between the respective one end portions (the respective first end portions) of the lock plates 14, 14, and the lock plates 14, 14 are forced by this lock spring 15 in the direction in which the respective one end portions (the respective first end portions) are separated from each other. Therefore, as will be described later, the width-across-flat portions 21d, 21d, functioning as the acting portions, of the irregular shaped shaft portion 12d come into contact with the two sets of lock plates 14 and 16 without a gap in the rotational direction.

It is noted that although the width-across-flat portions 21d, 21d of the pinion shaft 12 shown in FIG. 7 are formed as tapered surfaces that slant to upper and lower end portions with their middle portions in a vertical direction being apexes, the width-across-flat portions 21d, 21d could be simple flat surfaces having no slant.

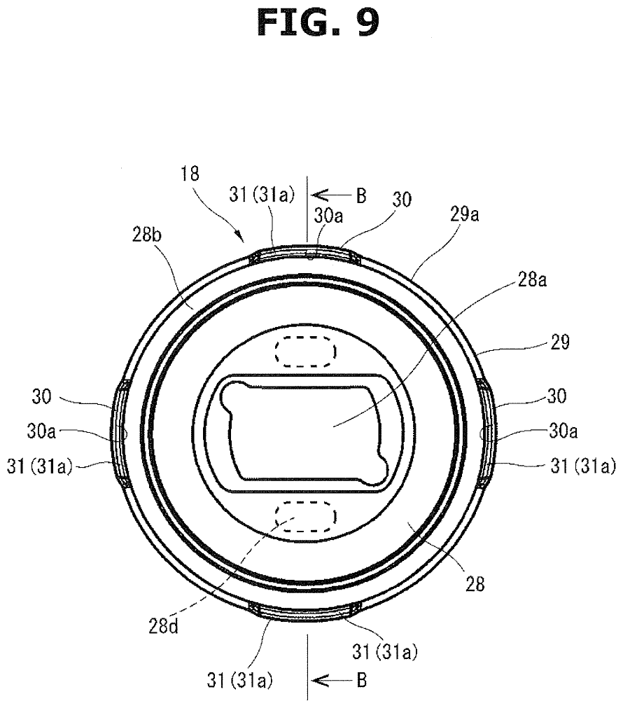

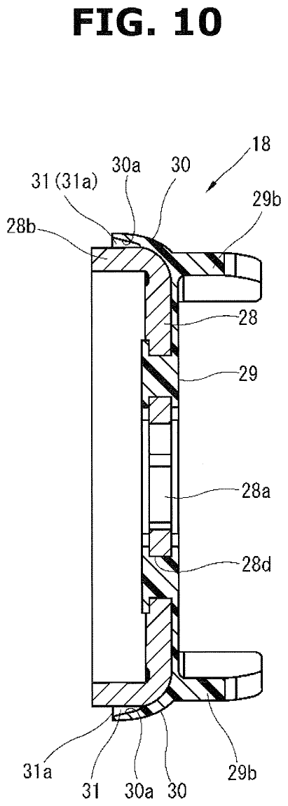

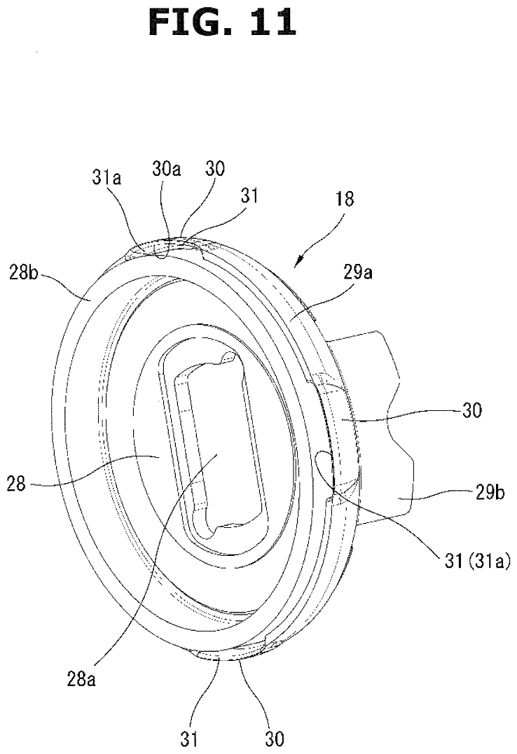

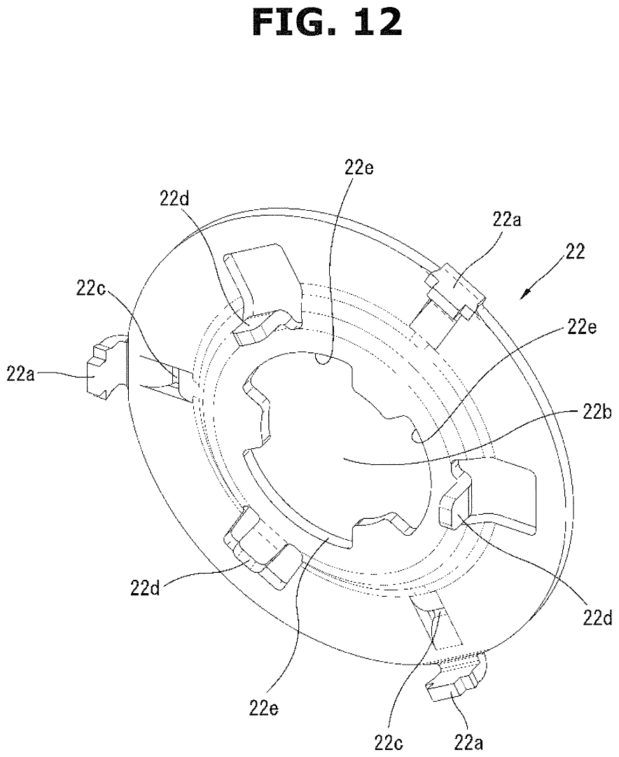

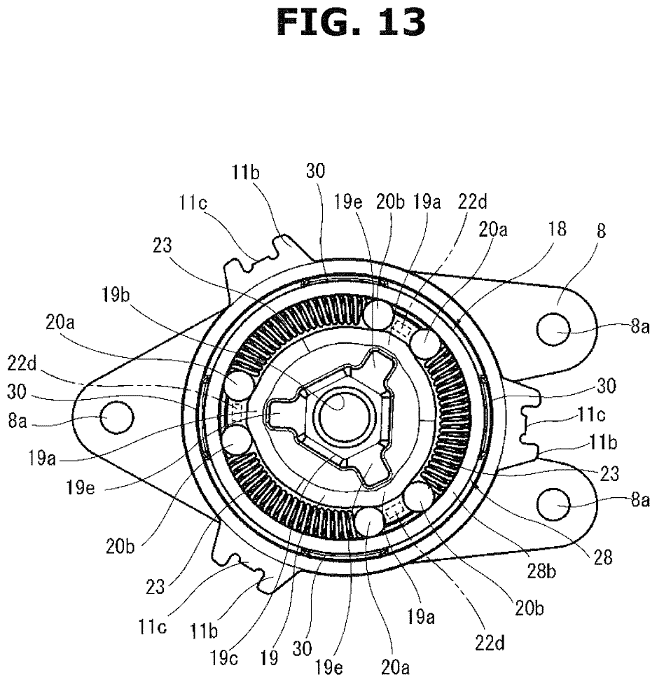

FIG. 9 is a front view of the drive wheel 18 used in the present embodiment. FIG. 10 is a sectional view taken along a line B-B of FIG. 9. FIG. 11 is a perspective view of the drive wheel 18 used in the present embodiment. FIG. 12 is a perspective view of the cover member 22 used in the present embodiment. FIG. 13 is a front view showing the drive mechanism section 10 with the lever bracket 24 and the cover member 22 removed.

As illustrated in FIGS. 9 to 11, the drive wheel 18 of the drive mechanism section 10 shown in FIG. 6 has the rectangular hole 28a formed at a center thereof, a disk-shaped drum portion 28 having an annular outer ring portion 28b at its outer periphery, and a resin portion 29 formed so as to cover an inner bottom portion and an outer peripheral portion of the drum portion 28.

The drum portion 28 is formed into a shallow dish shape by press working of iron-based metal plate member. Furthermore, the rectangular hole 28a, to which the irregular shaped shaft portion 12d of the pinion shaft 12 is fitted so that the drum portion 28 (the drive wheel 18) and the irregular shaped shaft portion 12d of the pinion shaft 12 can integrally rotate, is formed at the center of the drum portion 28 so as to penetrate the drum portion 28 in the axial direction. Also, the drum portion 28 is provided, at the outer periphery thereof, with the flange-shaped annular outer ring portion 28b formed integrally with the drum portion 28. An inner peripheral surface 28c of the outer ring portion 28b is formed into a perfect circle. Outer peripheral surfaces of the plurality of rollers 20 mentioned above come into press-contact with this inner peripheral surface 28c through the wedge cam 19 described later, and the inner peripheral surface 28c functions as a frictional surface that applies wedge frictional force to the plurality of rollers 20. The drum portion 28 is further provided with two through holes 28d at both sides of the rectangular hole 28a. These through holes 28d are used as fixing portions for integration when insert-molding the resin portion 29.

The resin portion 29 is formed on an outer surface and the inner bottom portion of the drum portion 28 and on an outer peripheral surface of the outer ring portion 28b etc. with a synthetic resin such as PA 66 (Polyamide/nylon 66) by so-called insert molding. Furthermore, an outer peripheral portion 29a of the resin portion 29 is formed into an annular shape that cover the outer ring portion 28b.

The pair of arc-shaped release nail portions 29b protruding toward the two sets of lock plates 14 and 16 are formed integrally with a back side of the drive wheel 18, i.e. a back side of the outer peripheral portion 29a of the resin portion 29. That is, these release nail portions 29b are formed as parts of the resin portion 29.

In addition, at an outer peripheral side of the drive wheel 18, i.e. at the outer peripheral portion 29a, formed so as to cover the outer ring portion 28b of the drum portion 28, of the resin portion 29, frictional resistance portions 30 are arranged so as to face the cylindrical tubular frictional surface 13 of the housing 11 in a radial direction.

As illustrated in FIGS. 9 to 11, four frictional resistance portions 30 are provided at regular intervals of about 90°in a circumferential direction of the outer peripheral portion 29a of the resin portion 29. Each frictional resistance portion 30 is formed into an inclined shape rising from the housing 11 side toward the lever bracket 24, and also formed into an arc shape having a predetermined length along the circumferential direction of the outer peripheral portion 29a. Between an inner surface 30a of each frictional resistance portion 30 formed into the inclined shape rising from the housing 11 side toward the lever bracket 24 and the outer peripheral surface of the outer ring portion 28b of the drum portion 28, an arc-shaped gap portion 31 is formed.

Since the frictional resistance portion 30 has the structure obliquely rising toward the lever portion, an opening portion 31a that is open to the lever bracket 24 side is formed at the gap portion 31. The gap portion 31 then allows an elastic deformation of the frictional resistance portion 30 in the radial direction, and applies this elastic force to the frictional resistance portion 30. The structure of the frictional resistance portion 30 brings ease of insertion of the drive wheel 18 into the housing 11 when accommodating the drive wheel 18 in the housing 11, and causes an outer surface of each frictional resistance portion 30 to come into elastically press-contact with the cylindrical tubular frictional surface 13 of the housing 11 in the radial direction.

Here, as described above, predetermined play in the rotational direction is given between the rectangular hole 28a of the drive wheel 18 and the irregular shaped shaft portion 12d of the pinion shaft 12.

As illustrated in FIG. 12, the cover member 22 of the drive mechanism section 10 shown in FIG. 6 is formed into a substantially disk shape by, for instance, press working of a metal plate member. This cover member 22 has, at 120° angular positions in a circumferential direction of an outer peripheral edge thereof, three nail portions 22a that are engaged with the respective engagement recessed portions 11c of the housing 11 when being connected to the housing 11. The cover member 22 also has, at a center thereof, a compound leaf-shaped fitting opening 22b that penetrates the cover member 22 in the axial direction.

As depicted in FIGS. 2 and 4, top end portions of the three nail portions 22a are each crimped after being fitted into the respective engagement recessed portions 11c of the housing 11, thereby fixing the cover member 22 to the housing 11. The fitting opening 22 b has, at 120° angular positions in the circumferential direction of an outer peripheral edge thereof, three sector opening portions 22e that allow rotation of three protruding portions 19e of a fitting protrusion 19c, both described later, of the wedge cam 19.

Furthermore, as illustrated in FIGS. 3, 4, 6 and 12, the cover member 22 also has three protrusions 22c at positions corresponding to the nail portions 22a on one end surface, on the lever bracket 24 side, of the cover member 22. These three protrusions 22c are located in after-described three window openings 24d of the lever bracket 24 respectively. Moreover, the cover member 22 has, at 120° angular positions in the circumferential direction and between the protrusions 22c, three protruding pieces 22d that protrude toward the wedge cam 19. Each protruding piece 22d is formed by cutting and raising a part of a peripheral wall of the cover member 22. More specifically, each protruding piece 22d is formed by cutting a part of the peripheral wall of the cover member 22 and bending it at a substantially right angle toward the wedge cam 19 with respect to the peripheral wall of the cover member 22. The protruding pieces 22d are each positioned between after-described two rollers 20a and 20b of the plurality of rollers 20. Each of the protruding pieces 22d restricts rotational movement (rolling movement) of either one of roller 20a or 20b during rotation of the wedge cam 19.

As illustrated in FIG. 13, the disk-shaped wedge cam 19 of the drive mechanism section 10 shown in FIG. 6 is substantially circular in front view, and has, at 120° angular positions in a circumferential direction, three cam portions 19a that protrude outwards in a radial direction. Therefore, in a state in which the wedge cam 19 is placed between the drive wheel 18 and the cover member 22, each protruding piece 22d (shown by a virtual line in FIG. 13) of the cover member 22 is located in a wedge-shaped gap formed between the inner peripheral surface 28c of the outer ring portion 28b of the drive wheel 18 and an outer peripheral surface of the cam portion 19a.

The wedge cam 19 has, at a center thereof, a female screw hole 19b that penetrates the wedge cam 19 in the axial direction. The wedge cam 19 also has, on an outer surface at the lever bracket 24 side thereof, the substantially triangular fitting protrusion 19c formed integrally with the wedge cam 19. This fitting protrusion 19c has the three protruding portions 19e extending from an inner periphery of the middle of the fitting protrusion 19c in the radial direction. The fitting protrusion 19c protrudes to the outside through the fitting opening 22b of the cover member 22, and is fitted to an after-described fitting recessed portion 24c of the lever bracket 24 in a fitted state. With this, the wedge cam 19 can rotate integrally with the lever bracket 24.

The six rollers 20 of the drive mechanism section 10 shown in FIG. 6 are formed with a metal material, and have the same outside diameter and the same axial length. As seen in FIG. 13, two rollers 20a and 20b are arranged at both sides of each cam portion 19a of the wedge cam 19. As mentioned above, each protruding piece 22d of the cover member 22 is disposed in the axial direction between these adjacently arranged two rollers 20a and 20b. Therefore, the right and left rollers 20a and 20b are arranged at opposite sides of each protruding piece 22d of the cover member 22 in the gap between the outer peripheral surface of each cam portion 19a and the inner peripheral surface 28c of the outer ring portion 28b of the drive wheel 18, and the outer surface of each cam portion 19a presses the rollers 20a and 20b by and according to rotation of the wedge cam 19, thereby bringing about a wedge effect.

As illustrated in FIG. 13, the three roller forcing springs 23 of the drive mechanism section 10 shown in FIG. 6 are each formed by an axially long coil spring. Each roller forcing spring 23 is arranged in a circumferential direction along the inner peripheral surface 28c of the outer ring portion 28b of the drive wheel 18 between adjacent two cam portions 19a of the wedge cam 19. Both end portions, in the axial direction, of the roller forcing spring 23 come into elastic contact with the roller 20a of one pair of rollers 20a and 20b and the roller 20b of the other pair of rollers 20a and 20b from the circumferential direction respectively, thereby forcing these rollers 20a and 20b to directions of corresponding cam portions 19a.

With this configuration, when operating and rotating the operation lever 5 shown in FIG. 1 in either one of forward or reverse rotational direction from the neutral position, the cam portions 19a of the wedge cam 19 integrally rotates the drive wheel 18 through the rollers 20a or the rollers 20b. Subsequently, when releasing operation force of the operation lever 5 by releasing the rotational operation of the operation lever 5 and returning the operation lever 5 to the neutral position, the wedge cam 19 and the lever bracket 24 are each returned to the neutral position by the urging force of the roller forcing springs 23 through the rollers 20a or the rollers 20b, with the drive wheel 18 remaining at the rotated position. This will be described in detail in the following description of “Function of Brake Device”.

As illustrated in FIGS. 2 to 5, the lever bracket 24 of the drive mechanism section 10 shown in FIG. 6 is formed into a disk shape by press molding using a metal material. Furthermore, the screw insertion holes 24a, into which screws screwing into the operation lever 5 are inserted, are formed at two positions at an outer peripheral portion of the lever bracket 24. Moreover, a bolt insertion hole 24b into which a fixing bolt 32 is inserted is formed at a center of the lever bracket 24 so as to penetrate the lever bracket 24 in the axial direction. The fixing bolt 32 has a hexagonal head portion 32a, and a shaft portion 32b having, at its outer periphery, a male thread. By screwing the shaft portion 32b of the fixing bolt 32 into the female screw hole 19b of the wedge cam 19 through the bolt insertion hole 24b, the wedge cam 19 is engaged with and fixed to the lever bracket 24.

In addition, the fitting recessed portion 24c to which the fitting protrusion 19c of the wedge cam 19 is fitted from the axial direction is formed around the bolt insertion hole 24b of the lever bracket 24 by press molding. The fitting recessed portion 24c has the same outside shape as that of the fitting protrusion 19c, and the entire fitting protrusion 19c is fitted to the fitting recessed portion 24c in a fitted state. Therefore, the lever bracket 24 and the wedge cam 19 integrally rotates, and a rotational force of the lever bracket 24 can be efficiently transmitted to the wedge cam 19.

The three arc-shaped window openings 24d are also formed at regular intervals of 120° in a circumferential direction of the outer peripheral portion of the lever bracket 24. As mentioned above, the three protrusions 22c of the cover member 22 are inserted in and engaged with the respective window openings 24d, thereby limiting a rotation range of the lever bracket 24 when the lever bracket 24 rotates in the forward and reverse rotational directions.

### Function of Brake Device

Function or workings of the brake device 7 configured as above will be explained below.

In a state in which there is no rotational operation of the operation lever 5 together with the lever bracket 24 at a position shown in FIG. 3, as illustrated in FIGS. 3 and 13, the wedge cam 19 has been maintained in the neutral state together with the rollers 20 by the urging force of the roller forcing springs 23.

That is, in the neutral state shown in FIGS. 3 and 13, also the wedge cam 19 in the drive mechanism section 10 is at an initial neutral position by the spring force of each roller forcing spring 23 through each roller 20. Therefore, as shown in FIG. 13, the drive wheel 18 has been maintained at an initial rotational position.

At the same time, as illustrated in FIG. 7, in the brake mechanism section 9, the one convex portions 14b, 16b of the lock plates 14 and the lock plates 16, which are forced by the lock springs 15 and 17 respectively, are each pressed against the width-across-flat portions 21d, 21d of the pinion shaft 12. Also, the both end brake lock surfaces 26 of the lock plates 14 and the lock plates 16 are each in press-contact with the cylindrical tubular frictional surface 13 of the housing 11. Therefore, the pinion shaft 12 is prevented from rotating in both of the forward and reverse rotational directions. That is, by frictional force between both of the brake lock surfaces 26 of the lock plates 14 and the lock plates 16 and the cylindrical tubular frictional surface 13 of the housing 11, their braking state is maintained.

In this case, even if a reverse input from the seat lifter mechanism due to seating of an occupant acts on the brake device 7, by the frictional force between the cylindrical tubular frictional surface 13 of the housing 11 and the brake lock surfaces 26 of the lock plates 14 and the lock plates 16, their braking state can be maintained. In this manner, in the brake mechanism section 9, the cylindrical tubular frictional surface 13 of the housing 11, and the two sets of lock plates 14 and 16 including the lock springs 15 and 17 function as direct braking elements.

On the other hand, to release the braking state of the brake mechanism section 9 in the brake device 7 when adjusting the height position of the seat cushion 3 by the seat lifter mechanism, the rotational operation of the operation lever 5 together with the lever bracket 24 of the drive mechanism section 10 in the forward or reverse rotational direction is carried out.

The rotational operation of the operation lever 5 together with the lever bracket 24 in the forward or reverse rotational direction from the neutral state of the drive mechanism section 10 shown in FIGS. 3 and 13, for instance, the rotational operation in a clockwise direction from the state of FIG. 3, will be described.

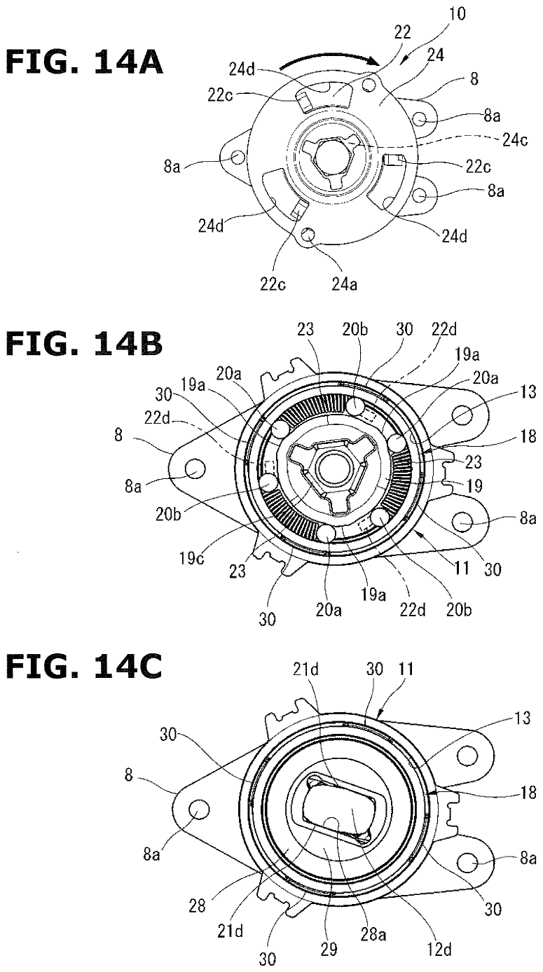

FIGS. 14A to 14C show a state in which the lever bracket 24 is rotated in the clockwise direction from the neutral position. FIG. 14A is a front view when viewed from the lever bracket 24 side. FIG. 14B is a front view of the drive mechanism section 10 with the lever bracket 24 and the cover member 22 removed. FIG. 14C is a front view of the drive wheel 18 with the drive mechanism section 10 removed.

As illustrated in FIG. 14A, when rotating the lever bracket 24 in the clockwise direction (a direction shown by an arrow) by the rotational operation of the operation lever 5, as shown in FIG. 14B, the wedge cam 19 of the drive mechanism section 10 also integrally rotates in the same direction. Then, the cam portions 19a of the wedge cam 19 rotate (or roll) and move the one-side three rollers 20a respectively in the clockwise direction against the spring force of the roller forcing springs 23. At this time, by the wedge effect by the rotation of the cam portions 19a, the outer peripheral surfaces of the rollers 20a come into press-contact with the inner peripheral surface 28c of the outer ring portion 28b of the drum portion 28 of the drive wheel 18, thereby also rotating the drive wheel 18 in the clockwise direction. That is, by the wedge effect of each roller 20a, the drive wheel 18 is made to rotate in the clockwise direction.

At this time, as for the other-side three rollers 20b, as shown in FIG. 14B, their rotational movement (rolling movement) is limited by the three protruding pieces 22d (shown by virtual lines) of the cover member 22 that has been in a fixed state through the housing 11, and the three rollers 20b are pressed by the spring force of the respective roller forcing springs 23.

The drive wheel 18 having been driven and rotated by the wedge effect by the wedge cam 19 and the rollers 20a first releases restriction of rotation of the pinion shaft 12 caused by the two sets of lock plates 14 and 16. That is, by and according to the rotation of the drive wheel 18 in the clockwise direction, the two release nail portions 29b of the drive wheel 18 shown in FIG. 7 rotate the lock plates 14 and 16 in the same direction. With this, a held state of the width-across-flat portions 21d, 21d of the pinion shaft 12 between the two sets of lock plates 14 and 16 is released, then the braking state, having been maintained, of the brake mechanism section 9 is substantially released. By this release of the braking state, the pinion shaft 12 can rotate together with the two sets of lock plates 14 and 16 with respect to the housing 11.

Next, as illustrated in FIG. 14C, by the rotation of the drive wheel 18 pressed by the rollers 20a, the pinion shaft 12 rotates after rotating by a rotational amount of the predetermined play given between the rectangular hole 28a of the drive wheel 18 and the width-across-flat portions 21d, 21d of the irregular shaped shaft portion 12d of the pinion shaft 12. The width-across-flat portions 21d, 21d abut against the rectangular hole 28a, thereby rotating the pinion shaft 12 in the clockwise direction from the position of FIG. 7. This rotation of the pinion shaft 12 is rotation of the pinion gear 12a. By this rotation of the pinion gear 12a, the driven-side gear (not shown), which is engaged with the pinion gear 12a, of the seat lifter mechanism rotates, thereby changing the height position of the seat 1 (the seat cushion 3), e.g. to a higher position.

As mentioned above, since a vertical displacement of the seat 1 shown in FIG. 1 based on the function of the seat lifter mechanism is small for a rotational operation amount of the operation lever 5, in many cases, the rotational operation of the operation lever 5 is repeated multiple times.

Here, when releasing operation force of the operation lever 5, in addition to the operation lever 5, the rollers 20a and the wedge cam 19 of the drive mechanism section 10 are returned to the initial state that is the neutral position shown in FIG. 13 from the state shown in FIG. 14B by returning force of the roller forcing springs 23.

At this time, the protruding pieces 22d of the cover member 22 restrict rotational movement, over the respective neutral positions, of the rollers 20a. Therefore, the cam portions 19a of the wedge cam 19 do not abut on the rollers 20b, and rotation of the wedge cam 19 is not transmitted to the drive wheel 18. Thus, the drive wheel 18 remains at the previously rotated position through the frictional resistance portions 30. The wedge cam 19 and the rollers 20a are returned to the initial state shown in FIG. 13 without rotation of the drive wheel 18 and the pinion shaft 12.

Next, the rotational operation of the operation lever 5 together with the lever bracket 24 in the reverse rotational direction, i.e. in a counterclockwise direction, from the neutral state of the drive mechanism section 10 shown in FIG. 13 will be described.

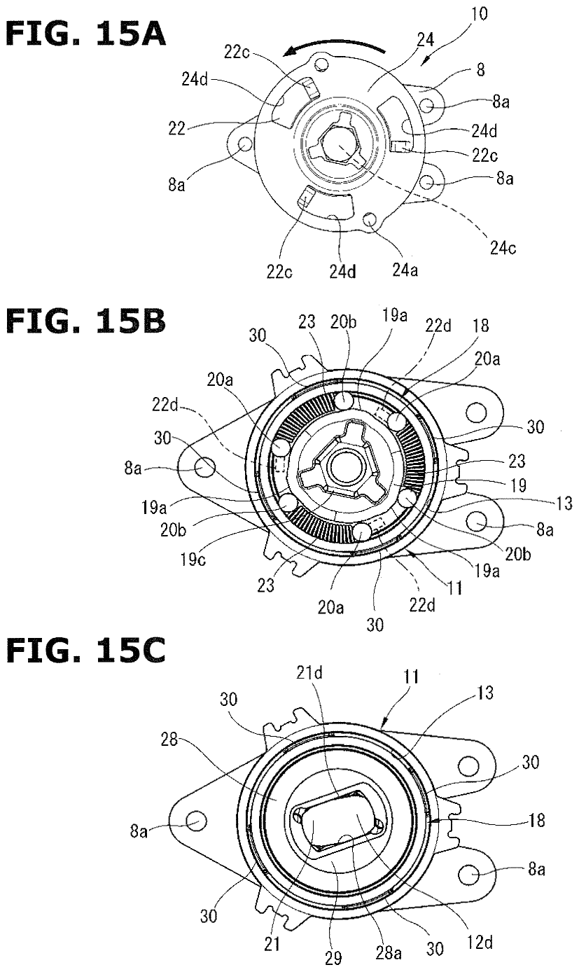

FIGS. 15A to 15C show a state in which the lever bracket 24 is rotated in the counterclockwise direction from the neutral position. FIG. 15A is a front view when viewed from the lever bracket 24 side. FIG. 15B is a front view of the drive mechanism section 10 with the lever bracket 24 and the cover member 22 removed. FIG. 15C is a front view of the drive wheel 18 with the drive mechanism section 10 removed.

As illustrated in FIG. 15A, when rotating the lever bracket 24 in the counterclockwise direction (a direction shown by an arrow) by the rotational operation of the operation lever 5, as shown in FIG. 15B, the wedge cam 19 of the drive mechanism section 10 also integrally rotates in the same counterclockwise direction. Then, the cam portions 19a of the wedge cam 19 rotate (or roll) and move the other-side three rollers 20b respectively in the counterclockwise direction against the spring force of the roller forcing springs 23. At this time, by the wedge effect by the rotation of the cam portions 19a, the outer peripheral surfaces of the rollers 20b come into press-contact with the inner peripheral surface 28c of the outer ring portion 28b of the drum portion 28 of the drive wheel 18, thereby also rotating the drive wheel 18 in the counterclockwise direction.

At this time, as for the one-side three rollers 20a, their rotational movement (rolling movement) is limited by the three protruding pieces 22d (shown by virtual lines) of the cover member 22 that has been in a fixed state through the housing 11, and the three rollers 20a are pressed against the respective protruding pieces 22d by the spring force of the respective roller forcing springs 23.

The drive wheel 18 having been driven and rotated in the counterclockwise direction first releases restriction of rotation of the pinion shaft 12 caused by the two sets of lock plates 14 and 16. That is, by and according to the rotation of the drive wheel 18 in the counterclockwise direction from the position shown in FIG. 7, the two release nail portions 29b of the drive wheel 18 rotate the lock plates 14 and 16 in the same counterclockwise direction. With this, a held state of the width-across-flat portions 21d, 21d of the pinion shaft 12 between the two sets of lock plates 14 and 16 is released, then the braking state, having been maintained, of the brake mechanism section 9 is substantially released. By this release of the braking state, the pinion shaft 12 can rotate together with the two sets of lock plates 14 and 16 with respect to the housing 11.

Next, as illustrated in FIG. 15C, by the rotation of the drive wheel 18 pressed by the rollers 20b, the pinion shaft 12 rotates after rotating by a rotational amount of the predetermined play given between the rectangular hole 28a of the drive wheel 18 and the width-across-flat portions 21d, 21d of the irregular shaped shaft portion 12d of the pinion shaft 12. The width-across-flat portions 21d, 21d abut against the rectangular hole 28a, thereby rotating the pinion shaft 12 in the counterclockwise direction from the position of FIG. 7. This rotation of the pinion shaft 12 is rotation of the pinion gear 12a. By this counterclockwise rotation of the pinion gear 12a, the driven-side gear (not shown), which is engaged with the pinion gear 12a, of the seat lifter mechanism rotates, thereby changing the height position of the seat 1 (the seat cushion 3), e.g. to a lower position.

Here, when releasing operation force of the operation lever 5, in addition to the operation lever 5, the rollers 20b and the wedge cam 19 of the drive mechanism section 10 are returned to the initial state that is the neutral position shown in FIG. 13 from the state shown in FIG. 15B by returning force of the roller forcing springs 23. At this time, the cam portions 19a of the wedge cam 19 do not abut on the rollers 20a, and rotation of the wedge cam 19 is not transmitted to the drive wheel 18. Therefore, the drive wheel 18 remains at the previously rotated position through the frictional resistance portions 30. The wedge cam 19 and the rollers 20b are returned to the initial state shown in FIG. 13 without rotation of the drive wheel 18 and the pinion shaft 12.

### Working and Effect of the Present Embodiment

The drive wheel 18 has, at four positions of the outer peripheral portion 29a thereof, the frictional resistance portions 30 that are constantly in press-contact with the cylindrical tubular frictional surface 13 of the housing 11 by their elastic force. Therefore, the following workings and effects can be obtained.

As described above, by the rotational operation of the operation lever 5 together with the lever bracket 24 in the forward or reverse rotational direction from the neutral state of the drive mechanism section 10, the wedge cam 19 etc. are brought into the braking state at a forward or reverse rotational position. Subsequently, when releasing the rotational operation of the operation lever 5 and returning the operation lever 5 to the neutral position, since the four frictional resistance portions 30 of the drive wheel 18 are in elastic contact with the cylindrical tubular frictional surface 13 of the housing 11, drag rotation of the drive wheel 18 with the wedge cam 19 is suppressed.

That is, by the release of the rotational operation of the operation lever 5 (the lever bracket 24), the wedge effect of the one-side rollers 20a or 20b is cancelled, and the wedge cam 19 is returned to the neutral rotational position by the urging force of the roller forcing springs 23. At this time, the cam portions 19a of the wedge cam 19 do not abut on the other-side rollers 20b or 20a, but the one-side rollers 20a or 20b are pressed on the cam portions 19a by the urging force of the roller forcing springs 23. Because of this, frictional resistance occurs, which is small though, between the one-side rollers 20a or 20b and the drive wheel 18, and due to this frictional resistance, the drive wheel 18 tends to rotate in the same neutral position. However, as described above, since the outer surfaces of the frictional resistance portions 30 of the drive wheel 18 press the cylindrical tubular frictional surface 13 of the housing 11 by their elastic force and thus the frictional force enough for the braking is generated between the drive wheel 18 and the housing 11, drag rotation of the drive wheel 18 with the wedge cam 19 is suppressed. Therefore, a stable and reliable operation of the seat lifter mechanism by the operation lever 5 can be obtained.

Furthermore, the four frictional resistance portions 30 are provided at 90° angular positions in the circumferential direction. Therefore, sufficient and stable frictional force is secured between each frictional resistance portion 30 and the cylindrical tubular frictional surface 13 of the housing 11, thereby further suppressing drag rotation of the drive wheel 18.

Also, in order to suppress drag rotation of the drive wheel 18, the frictional resistance portions 30 are merely formed integrally with the drive wheel 18. Therefore, unlike the related art technique, there is no need to provide the wave washer as an additional element between the brake housing and the drive wheel. It is thus possible to reduce parts count, which in turn improve manufacturing workability and reduce manufacturing costs.

Moreover, when the resin portion 29 is molded onto the drum portion 28, the frictional resistance portions 30 of the drive wheel 18 can be formed integrally with the outer peripheral portion 29a of the resin portion 29 at the same time. It is therefore possible to further improve manufacturing workability.

In addition, the gap portion 31 applying the elastic force to the frictional resistance portion 30 is formed inside each frictional resistance portion 30. Therefore, each frictional resistance portion 30 can come into elastically press-contact with the cylindrical tubular frictional surface 13 of the housing 11. With this, long-term stable frictional force between the drive wheel 18 and the housing 11 can be secured.

The gap portion 31 has the opening portion 31a at its axially one side. This structure eases the elastic deformation of the frictional resistance portion 30, in comparison with a case where the opening portion 31a is not formed. It is thus possible to elastically press the frictional resistance portion 30 against the cylindrical tubular frictional surface 13 of the housing 11 with ease.

Additionally, in the present embodiment, the release nail portions 29b that release the braking state of the pinion shaft 12 are formed integrally with the resin portion 29 of the drive wheel 18. Since the release nail portions 29b are formed integrally with the resin portion 29 at the same time upon resin molding, as compared with a case where the release nail portions are provided as separate members, it is possible to improve manufacturing workability and reduce manufacturing costs.

The present invention is not limited to the configuration or structure described in the above embodiment. For instance, regarding the frictional resistance portion 30 provided at the outer peripheral portion 29a of the resin portion 29, as long as at least three frictional resistance portions 30 are provided, its number is not limited. Furthermore, in the above embodiment, the gap portion 31 provided inside the frictional resistance portion 30 has the opening portion 31a at its one side. However, the gap portion 31 may have openings that are axially open to both sides of the frictional resistance portion 30.

The brake device 7 according to the above embodiment has the brake mechanism section 9 using the two sets of lock plates 14 and 16. However, the brake mechanism section using the two sets of lock plates can also be applied to the brake device having the brake mechanism section using the plurality of rollers as disclosed in the related art.

### EXPLANATION OF REFERENCE

5 . . . operation lever
7 . . . brake device
8 . . . mounting bracket
9 . . . brake mechanism section
10 . . . drive mechanism section
11 . . . housing
11a . . . shaft bore
12 . . . pinion shaft (output shaft)
12a . . . pinion gear
12b . . . large diameter shaft portion
12c . . . top end shaft portion
14, 16 . . . lock plate
15, 17 . . . lock spring
18 . . . drive wheel
19 . . . wedge cam
19a . . . cam portion
19b . . . female screw hole
19c . . . fitting protrusion
20, 20 a, 20b . . . roller
22 . . . cover member
23 . . . roller forcing spring
24 . . . lever bracket

What is claimed is

1. A brake device of a vehicle seat comprising:
a brake mechanism section including a drive-side gear provided at one end of an output shaft, the brake mechanism section configured to cause the output shaft to be in a braking state so that the output shaft does not rotate against a reverse input that is input from a drive-side gear side; and
a drive mechanism section configured to, when operating and rotating an operating member in either one of forward or reverse rotational direction from a neutral position, release the braking state of the output shaft and allow rotation of the output shaft in the one of forward or reverse rotational direction,
wherein the brake mechanism section and the drive mechanism section are provided in a seat adjuster of the vehicle seat, and are coaxially aligned with each other,
wherein the brake mechanism section further includes a brake housing having, on an inner peripheral surface thereof, a cylindrical tubular frictional surface,
wherein the drive mechanism section includes a drive wheel disposed inside the brake housing and structured to release the braking state of the output shaft and further drive and rotate the output shaft integrally with the operating member, and
wherein the drive wheel has, on an outer periphery thereof, frictional resistance portions that come into press-contact with the cylindrical tubular frictional surface of the brake housing by elastic force of the frictional resistance portions at at least three positions in a circumferential direction of the drive wheel.

2. The brake device of the vehicle seat as claimed in claim 1, wherein
the drive wheel has a disk-shaped metal drum portion having, on an outer periphery thereof, a cylindrical tubular outer ring portion, and also has a resin portion formed so that a part of the resin portion covers an outer peripheral surface of the outer ring portion of the drum portion, and
the resin portion has, at an outer peripheral side thereof, the frictional resistance portions that cover the outer peripheral surface of the outer ring portion, and that come into elastic contact with the cylindrical tubular frictional surface of the brake housing from a radial direction of the resin portion.

3. The brake device of the vehicle seat as claimed in claim 2, wherein
a gap portion that allows an elastic deformation of the frictional resistance portion in the radial direction and applies an elastic force, generated by the elastic deformation, to the frictional resistance portion is formed between the outer ring portion of the drum portion and each frictional resistance portion of the resin portion.

4. The brake device of the vehicle seat as claimed in claim 3, wherein
at least one side of the gap portion in an axial direction of the drive wheel is open.

5. The brake device of the vehicle seat as claimed in claim 2, wherein
the resin portion of the drive wheel has an integrally-molded release nail portion structured to release the braking state of the output shaft of the brake mechanism section.
